(19) United States
(12) Patent Application Publication
(10) Pub. No.: US 2020/0010068 A1
(43) Pub. Date: Jan. 9, 2020

(54) ACTUATOR HAVING A DRIVE UNIT AND GEAR UNIT

(71) Applicant: Robert Bosch GmbH, Stuttgart (DE)

(72) Inventors: Willi Nagel, Remseck/Hochdorf (DE); Andre Bollwerk, Steinheim An Der Murr (DE); Daniel Weissinger, Korntal-Muenchingen (DE)

(21) Appl. No.: 16/483,853

(22) PCT Filed: Jan. 25, 2018
(86) PCT No.: PCT/EP2018/051805

§ 371 Date: Aug. 6, 2019

(30) Foreign Application Priority Data
Mar. 13, 2017 (DE) 102017204119.6

(51) Int. Cl. B60T 13/74; F16H 1/06

(52) U.S. Cl. CPC B60T 13/746; F16H 1/16; F16H 1/06

(57) ABSTRACT

An actuator including a drive unit for driving a gear unit of an actuator, the drive unit having an alignment element, which engages with a counter element of the gear unit to be driven, and a fixation arrangement/element is provided between the alignment element and the counter element, which allows the alignment element to be fixed in position in the counter element.

### FIELD OF THE INVENTION

The present invention relates to an actuator having a drive unit and a gear unit.

### BACKGROUND INFORMATION

The published patent application DE 102012222949 A1 discusses a transmission device which includes a worm shaft which is able to be set into a rotary motion by an electric motor, as well as a first worm wheel connected to a first pinion and a second worm wheel connected to a second pinion, which contact the worm shaft so that the first worm wheel and the first pinion are rotatable about a common first axis of rotation and the second worm wheel and the second pinion are rotatable about a common second axis of rotation. In addition, the transmission has an adjustable piston, which can be adjusted along an adjustment axis with the aid of the first pinion rotated about the first axis of rotation and the second pinion rotated about the second axis of rotation.

### SUMMARY OF THE INVENTION

The actuator according to the present invention includes a drive unit, which is fixed in position on a gear unit in the axial direction of a gear axle of the gear unit of the actuator.

The axial fixation is accomplished with the aid of a fixation element, which is introduced between an alignment element of the drive unit and a counter element of the gear unit. An actuator could be an electromechanical brake booster, for example. A drive unit, such as an electric motor, uses a gear unit to drive a piston, which implements a force transmission into a hydraulic brake system, for instance via a master brake cylinder. The electric brake booster as the actuator is capable of generating pressure in a hydraulic brake system on its own, or of doing so jointly with a driver in that it provides assistance to the driver when the driver is operating the brake.

This allows the drive unit to be secured on the gear unit with greater stability in the direction of the gear axle. The drive unit is thus not able to disengage from or lose contact with the gear unit, in particular in the direction of the gear axle. Preventing the drive unit from being suspended makes it possible to optimize a mechanical interaction between the drive unit and the gear unit in the form of a drive of a transmission which, as is common knowledge, is accomplished via toothed wheels, because a disengagement of the drive unit from the gear unit may lead to a change in the clearance of the toothed wheels.

In one further embodiment of the actuator, the counter element is part of a gear axle of the gear unit. The fixation in a counter element on a gear axle increases the stability of the connection between the drive unit and the gear unit in precisely this region. A fixation in the gear axle itself is particularly advantageous because bore holes and fastenings with the aid of screws or plugs often interfere in this area or may not even be possible at all, especially also for space-related reasons.

It is furthermore advantageous that the alignment element and the counter element complement each other. This allows for an uncomplicated interaction and assembly of the drive unit and the gear unit.

In an advantageous manner, the alignment element and the counter element as connection components complement each other in such a way that one of the two connection components is provided as a type of plug and the respective other of the two connection components is provided in the form of a socket. This allows for an adaptation to the respective requirements in cases where a socket or a plug is more easily mountable, in particular for space-related reasons. It is of course understood that the mating connection component must then be supplied on the other unit.

In one advantageous embodiment, the fixation element is mounted on the plug-type connection component of the two connection components, or in other words, on the particular part of the alignment element and the counter element that is provided as a plug or pin. A fixation element is easily attachable to a plug.

The plug-type connection component has an intermediate region in the form of an annular groove, and the fixation arrangement is accommodated in the annular groove. The annular groove advantageously prevents slippage of the fixation element, such as a tolerance ring. This is particularly advantageous during an assembly and disassembly of the drive unit on the gear unit. The annular groove furthermore allows for the precise positioning of the tolerance ring at the provided location of the plug-type connection component in the form of a pin. It is also advantageous that the provision of groove shoulders prevents excessive loading of the fixation element during the assembly. The groove protects the fixation element, so to speak.

In one further development of the actuator, the annular groove has lateral groove shoulders, which have different extensions starting at a groove bottom. The groove bottom connects the groove shoulders at the pin in the axial direction of the pin. The extension may also be understood as the height of the groove shoulders. The groove shoulders of different heights allow for a certain mobility in the form of tilting of the pin in the surrounding trough/hole/bore, which counteracts breakage of the pin itself or overloading of the pin at its fixation point, in particular overloading of the pin in the base region.

In one advantageous development, the higher groove shoulder is provided on the particular side of the groove bottom on which the plug-type connection component is connected on the gear unit or the drive unit. This depends on which one of the two units to be joined the pin as the plug-type connection component is provided or developed. The correct placement of the higher and lower shoulder allows for tolerable tilting in the appropriate direction and makes it possible to prevent overloading of the pin or the pin connection.

In an advantageous manner, the fixation arrangement of the actuator is a spring element, in particular a tolerance ring. The resilient property may be understood as pliability during the assembly of the alignment element and the counter element. The pliability allows the fixation element to yield under the action of force when it is introduced between the counter element and the alignment element. This also increases the holding force of the installed components relative to one another.

In an advantageous manner, in an axial fixation using the fixation arrangement, the fixation may also be reversed again. In this way, the components, i.e. drive unit and gear unit, are easily disassembled, for instance in order to exchange a drive unit. The disassembly may be accomplished without any destructive effects.

It is advantageously possible to adjust the axial fixation strength of the axial fixation via the configuration of the fixation arrangement. The fixation strength is thereby easily adjustable to the requirements of the particular situation.

In one development of the actuator, the fixation arrangement is a tolerance ring, which has waves at its outer circumference, which are compressed in the assembled state, especially partially compressed, between the alignment element and the counter element. The compressible waves give the fixation element the required already described pliability and allow for a force adjustment through the configuration of the waves via their dimensioning.

In an advantageous manner, the dimensioning of the waves is adjustable based on a length of individual waves and/or based on the number of waves and/or with the aid of a material of the waves.

In one development of the actuator, the alignment element is developed on a housing of the drive unit or mounted on a housing, in particular utilizing a motor flange.

Providing such a fixation element between the alignment element and counter element of an actuator allows for an effective reduction or prevention of an undesired movement, in particular a movement in the axial direction of the gear axle between the drive unit and gear unit. In addition, the use of a spring element between the alignment element and counter element achieves acoustic damping during loading of the gear unit.

Overall, the noise situation during the operation of the actuator is improved in this way.

Avoiding a movement of the drive unit in relation to the gear unit may also prevent a change in the positioning of toothed wheels that take part in the force transmission, thereby increasing the service life of the gear unit.

### BRIEF DESCRIPTION OF THE DRAWINGS

FIG. 1 shows a portion of an actuator with a gear unit and a drive unit.

FIG. 2 shows a drive unit of the actuator.

FIG. 3 shows a connection point between a drive unit and a gear unit.

FIG. 4 shows the drive unit of the actuator together with a motor flange.

FIG. 5 shows the connection point of the drive unit to the gear unit of the actuator including a fixation.

FIGS. 6, 7, 8, and 9 show details of the fixation for the connection between the drive unit and the gear unit.

FIGS. 10, 11, and 12 show systems of the fixation for different allocations of a pin and a receptacle for the pin to the gear unit and to the drive unit, respectively.

### DETAILED DESCRIPTION

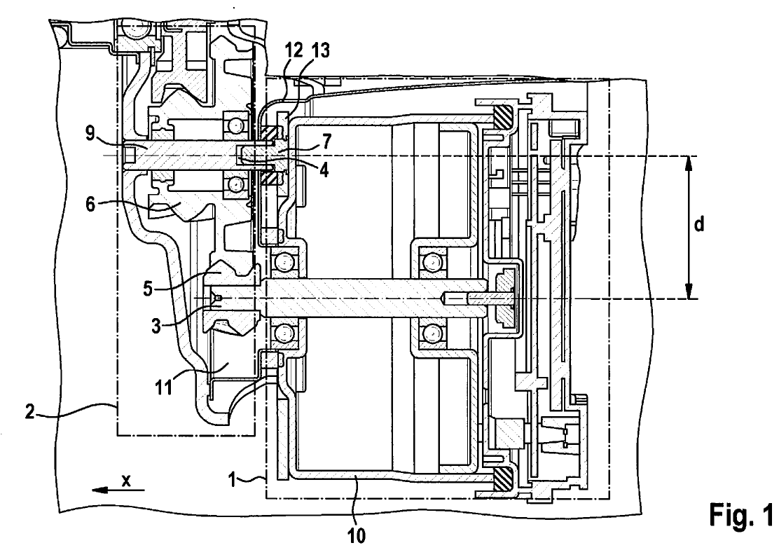

FIG. 1 shows a cutaway of an actuator, which includes at least a drive unit 1 as well as a gear unit 2. For example, such an actuator could be a brake booster which generates hydraulic brake pressure in a hydraulic brake system in that, driven by a motor, it displaces pressure pistons and generates a braking effect in a hydraulic brake system, either on its own, i.e. independently of the driver, or also in the form of a force assistance for a driver in the pressure buildup.

Drive unit 1 may be an electric motor 1, which has a drive axle 3. Drive axle 3 is rotatably mounted on a motor housing 10 and is mechanically connected to a motor pinion 5. Motor pinion 5 is attached to one end of drive axle 3 or is developed thereon, in particular in an integral manner.

Gear unit 2 has a gear wheel 6 to be driven. Gear wheel 6 is mounted on a gear axle 9. The mounting of the gear wheel 6 on gear axle 9 is such that gear wheel 6 is rotatable about gear axle 9. Gear unit 2 is able to induce a movement in an actuator, e.g., in a brake booster. For example, a spindle drive of a brake booster as the actuator is able to be driven via gear wheel 6.

Drive unit 1 drives gear wheel 6 of gear unit 2. Toward this end, a motor of drive unit 1 sets motor pinion 5 into rotation via drive axle 3. Motor pinion 5 is in engagement with gear wheel 6. An engagement of motor pinion 5 and gear wheel 6 may be accomplished with the aid of corresponding tooth systems of motor pinion 5 and gear wheel 6.

For the mechanical contacting of motor pinion 5 and gear wheel 6, motor pinion 5 is introduced into an interior space 11 of gear unit 2. This may be accomplished by guiding motor pinion 5 into interior space 11 through an opening in a housing part 12 of gear unit 2. Motor pinion 5 may already be installed on drive axle 3 or be molded there or connected thereto.

The introduction of motor pinion 5 into interior space 11 of the drive unit may be accomplished by assembling drive unit 1 with gear unit 2. To do so, drive unit 1 with motor pinion 5 may be moved in the direction of gear unit 2, for instance in installation direction x. In the same way, it is alternatively also possible to move gear unit 2 in the direction of drive unit 1.

In an interplay between motor pinion 5 and gear wheel 6, motor pinion 5 and gear wheel 6 should be accurately positioned relative to each other so that a mechanical engagement between the driving component (motor pinion 5) and the driven component (gear wheel 6) is carried out with sufficient precision. In addition, forces are also transmitted in an interplay of motor pinion 5 and gear wheel 6, which may cause a deviation from a previously exact positioning of the components on account of their loading.

Drive unit 1 has an alignment element 7, which ensures the exact positioning of motor pinion 5 in relation to gear wheel 6. In the same way, gear unit 2 includes a counter element 4, which likewise ensures the exact positioning of the motor pinion relative to gear wheel 6.

An alignment element 7, for example, is developed as a pin 7 or also as a lug 7. Such a pin 7 or lug 7 may be developed on housing 10 of drive unit 1. ‘Developed’, for one, may mean that alignment element 7 is developed in one piece with housing 10. Alternatively, alignment element 7 may be developed on housing 10 by being attached thereto, such as bonded, welded or screwed, for example. Other attachment methods are conceivable. It is also possible to attach a pin 7 to drive unit 1 via a motor flange 13 on which pin 7 is fixed in position and which serves as the connection between drive unit 1 and gear unit 2.

In the same way it is possible that alignment 7 is developed as a depression 7 or a trough 7 or a hole 7 in or on housing 10 of drive unit 1. Even in such a development of alignment element 7, alignment element 7 is able to be mounted on the housing or also be developed in the housing. Known fixation types may also be used as fastening techniques, especially the fastening techniques mentioned in connection with the development as a pin or lug.

Counter element 4 of gear unit 2 is developed to be complementary to alignment element 7. ‘Complementary’ means that the geometrical dimensions of counter element 4 and alignment element 7 are such that they are able to engage with each other. If alignment element 7 is a pin, for example, then corresponding counter element 4 is provided in the form of a trough or hole. The diameter and depth of trough 4 or hole 4 is configured so that pin 7 is able to be at least partially accommodated in trough 4. In addition, the accommodation of pin 7 in trough 4 may be accomplished by force-locking. After its introduction—possibly using a press-in pressure—pin 7 may thus be retained in trough 4. In addition, the force-locked connection allows for a transmission of forces from one component to the other.

In the alternative case of a specific embodiment in which a trough is provided as an alignment element 7 on drive unit 1, complementary counter element 4 is provided in the form of pin 4.

As already described, gear unit 2 has a gear axle 9, which is mounted on housing 12 of gear unit 2. One end of gear axle 9 projects through an opening in gear housing 12 in the direction of drive unit 1. Counter element 4 is developed at the particular end of gear axle 9 that projects through the opening of gear housing 12.

Counter element 4 of gear unit 2 is developed on gear unit 2 at a location that lies across from alignment element 7 when gear unit 2 and drive unit 1 are assembled. In other words, the positionings of alignment element 7 on drive unit 1 as well as of counter element 4 on gear unit 2 match one another so that counter element 4 and alignment element 7 are able to engage with each other given a properly oriented assembly.

As described earlier, motor pinion 5 reaches interior space 11 of gear unit 2 through an opening in gear housing 12. The opening in gear housing 12 for motor pinion 5 and the respective positioning of alignment element 7 on drive unit 1 as well as of counter element 4 on gear unit 2 define an alignment in which drive unit 1 is to be assembled with gear unit 2. An accurate assembly of the parts is possible only if a corresponding alignment of gear unit 2 is provided in relation to drive unit 1.

A motor flange 13, which facilitates an attachment and/or connection of the two units, is provided between drive unit 1 and gear unit 2. In the illustrated embodiment, the mentioned alignment element 7 is attached to motor flange 13. Alternatively, the alignment element may also be integrally developed, e.g., molded, together with motor flange 13.

In the same way it is possible to develop alignment element 7 on drive unit 1 indirectly in the form of a depression or trough, for instance via motor flange 13. An indirect development on drive unit 1 via motor flange 13 may take the form of a bore 7, a hole 7, or a trough 7 in motor flange 13, motor flange 13 being attached to drive unit 1.

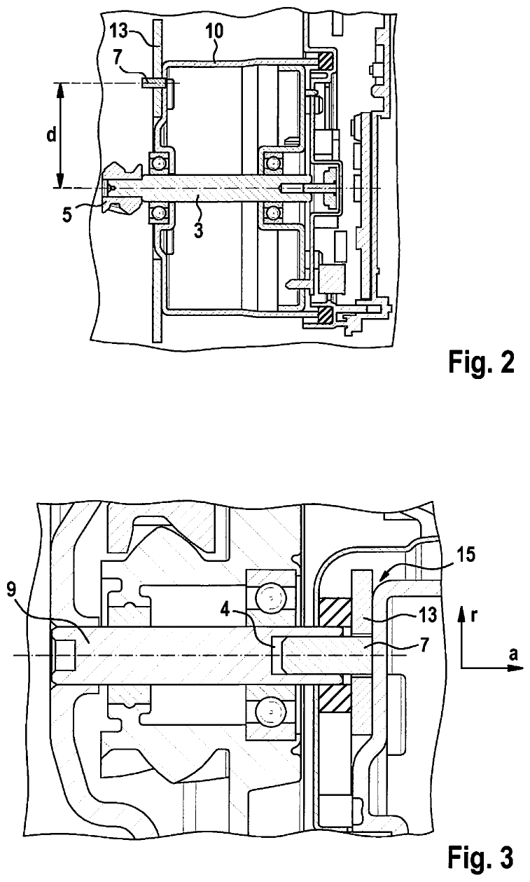

FIG. 2 shows drive unit 1 in the uninstalled state, that is, separate from gear unit 2. Drive axle 3, motor pinion 5, and clearance d between pin 7 and drive axle 3 are emphasized again in FIG. 2. This clearance d also defines the parallel offset at which pin 7 is situated in relation to drive axle 3. In the assembled state of drive unit 1 on gear unit 2, this clearance also corresponds to the relative parallel offset between drive axle 3 and gear axle 9. The specific embodiment illustrated in FIG. 2 includes alignment element 7 as the pin. The associated gear unit (which is not shown) must then have a trough 4 as a counter element 4 in gear axle 9. A trough or a hole 4 may be provided at this location instead of pin 7 shown in FIG. 2. Counter element 4 of associated gear unit 2 must then include a corresponding pin 7.

In the example of a drive unit 1 illustrated here, alignment element 7 is not formed on housing 10 of the drive unit but is attached thereto indirectly. The attachment of pin 7 is accomplished via motor flange 13, which is mounted on housing 10 of the drive unit. Thus, pin 7 is developed on drive unit 1 by being indirectly attached thereto. Pin 7 may be pressed into motor flange 13. In addition, pin 7 may be pressed in and crimped. The connection between pin 7 and motor flange 13 is a rigid connection. The connection between pin 7 and motor flange 13 is media-tight, or in other words, it is developed to seal from air and/or water.

FIG. 3 shows the engagement between an alignment element 7 in the form of a pin 7 and a counter element 4 in the form of a trough 4. In this particular embodiment, pin 7 is secured in motor flange 13, in particular pressed into it and crimped. Such a connection of drive unit 1 to gear unit 2 with the aid of pin 7 in trough 4 of gear axle 9 already offers excellent stability during an operation of the actuator. Excellent support, in particular in radial direction r (plotted in FIG. 3), is provided during loading of the gear unit in the course of an operation.

For an improved stability during loading of the gearing, the connection in axial direction a on pin 7 is able to be improved as well. This is the topic of the following sections.

For a simpler explanation, in the following considerations it is assumed that pin 7 is provided on drive unit 1, and a trough or a hole 4 is provided in the gear axle. However, it is understood, and will also still be discussed with the aid of examples, that a reverse constellation is possible as well.

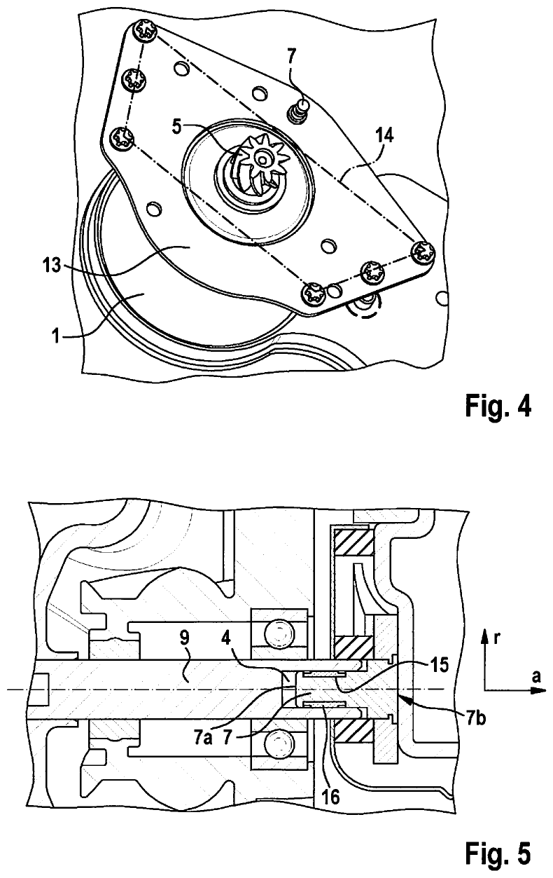

FIG. 4 shows another view of drive device 1. Motor pinion 5, which is meant to drive gear wheel 6 in the assembled state, is visible in the foreground. On the side of drive unit 1 that includes motor pinion 5, motor flange 13 is installed, which is connected to drive unit 1. As described earlier, pin 7 as alignment element 7 is attached to motor flange 13. Pin 7 is to be introduced into counter element 4, i.e. into trough 4 of gear axle 9 of gear unit 2.

Motor flange 13 has a shape that resembles a trapezoid. Due to the geometrical configuration of motor flange 13 as a trapezoid, it has a long base side 14.

When loading of gear unit 2 occurs because gear wheel 6 is driven by motor pinion 5, radial forces are generated at motor pinion 5 as well as the already mentioned radial and axial forces at pin 7.

Due to the low bending resistance of the motor flange attributable to the long base side 14, the forces that prevail during the operation may lead to an inclined position of drive unit 1, i.e. the motor, and thus of drive axle 3 together with motor pinion 5. The mechanical connection and force transmission between motor pinion 5 and gear wheel 6 may be worsened as a result and noise may develop due to the no longer optimal positioning of the gear wheel/motor pinion relative to each other.

This mobility of motor flange 13 is reduced by a specific embodiment that will be described in the following text with reference to FIG. 5.

A tolerance ring 16, which at least partially surrounds pin 7 along the circumference of pin 7, is mounted on pin 7. During the assembly of drive unit 1 and gear unit 2, this tolerance ring 16 is press-fitted between an outer circumferential surface of pin 7 and an inner surface of counter element 4, such as trough 4.

In addition, pin 7 may have an annular groove 15, which is developed on an intermediate section of pin 7. The intermediate section is situated between end 7a of pin 7 facing counter element 4, and connection 7b of pin 7 to motor flange 13 in the base region of pin 7.

Annular groove 15 is formed by a tapered region of pin 7 in the intermediate region. As far as the dimensions are concerned, annular groove 15 is to be configured so that it is able to accommodate tolerance ring 16. It may be sufficient to adapt the dimension of annular groove 15 to tolerance ring 16 in axial direction a. In radial direction r, tolerance ring 16 may project from annular groove 15.

Tolerance ring 16 may be clipped into annular groove 15. When installed between the outer circumference of pin 7 and the inner wall of counter element 4, tolerance ring 16 is able to transmit axial forces, i.e. forces in direction a, which are tensile or pressure forces, in particular. Radial forces, i.e. forces in direction r, are indirectly transmitted to gear axle 9 via pin 7, or directly via tolerance ring 16. By developing the axial forces in direction a, it is possible to counteract bending of motor flange 13 because gear axle 9 braces motor flange 13, which is soft in the axial direction and thus mobile. Due to this bracing of motor flange 13 on gear axle 9, tilting of drive unit 1 is thus able to be counteracted, and may be prevented, in particular.

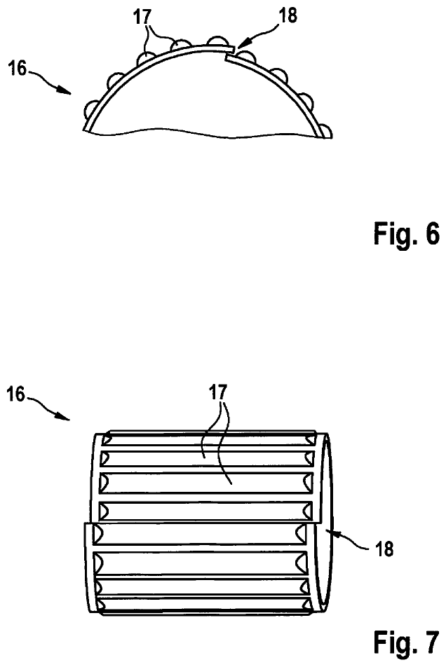

FIG. 6 shows a view of an upper half of a tolerance ring 16 in the unassembled state. Tolerance ring 16 has a slot 18 so that its width is variable. This allows for an uncomplicated assembly such as sliding tolerance ring 16 on and placing it in annular groove 15 of pin 7. Tolerance ring 16 is produced from a flexible material, in particular an elastic material. Sheet metal is one possible material.

In addition, tolerance ring 16 has waves 17, which are situated along the circumference of tolerance ring 16. These waves 17, too, are made of a deformable material which is able to yield under the influence of force. For example, a force directed toward the center of tolerance ring 16 may cause wave 17 to be upset or compressed in the direction of the center of tolerance ring 16. In functional terms, waves 17 may also be understood as springs 17, which may yield under the influence of force during the assembly, but by exerting a counterforce/a restoring force in the radial direction of tolerance ring 16. Tolerance ring 16, too, may be understood as spring element 16 as a whole.

FIG. 7 shows tolerance ring 16 in a side view. Waves 17 can be seen in this case, which are disposed along the axial extension of tolerance ring 16. In the unassembled state, a slight axial offset may be present in the region of slot 18.

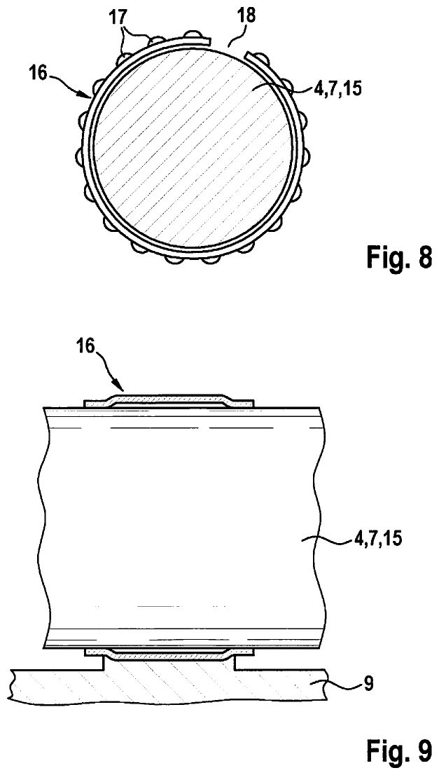

FIG. 8 shows a view along axial configuration a of pin 7 with an assembled tolerance ring 16. Waves 17 along the circumference of tolerance ring 16 may also be gathered from FIG. 8. Also visible is mentioned slot 18 in the form of an opening along the circumference of pin 7. In this view, groove 15 is not visible but is indicated via the reference numeral. In addition, tolerance ring 16 may also be secured on a pin, which is developed as counter element 4 on gear axle 9, which will be described once again in the further text. Reference numeral 4 has also been included for such a case.

FIG. 9 shows a side view of pin 7 as a sectional view. In this instance, it can be seen how tolerance ring 16 is present on both sides of pin 7 in the radial direction of pin 7. A wall of gear axle 9 is sketched as well. The second wall has not been shown in FIG. 9. In the assembled state, tolerance ring 16 is press-fitted between the wall of gear axle 9, which forms counter element 4, and pin 7. When tolerance ring 16 is press-fitted, a force is particularly exerted on waves 17, which yield in radial direction r of tolerance ring 16 and thereby secure pin 7 in counter element 4 in a frictionally engaged manner.

Groove 15 is not shown in this view, but indicated via the reference numeral. In addition, tolerance ring 16 may also be mounted on a pin, which is developed as a counter element 4 on gear axle 9, which will be explained once more in the following text. Reference numeral 4 has additionally been included for such a case.

Because of the fact that waves 17 are deformable, it is easily possible to install pin 7 in counter element 4 when drive unit 1 is assembled with gear unit 2. In the same way, it is possible to easily disassemble the components again. The present connection of pin 7 and counter element 4 thus involves a releasable connection. The assembly may advantageously be a blind assembly, i.e. without any further manual steps for securing pin 7 in counter element 4. Pressing pin 7 into counter element 4 of gear axle 9 will suffice.

Tolerance ring 16 may be configured in such a way that the dimensioning of the waves results in a tension force that is appropriate for the individual application case. A dimensioning of waves 17 includes the number of waves 17, the pliability/the elasticity of waves 17 and/or a length of the waves. The configuration of the tolerance ring specifies a fixation strength, which adjusts both the assembly forces and the fixation forces as well as the disassembly forces.

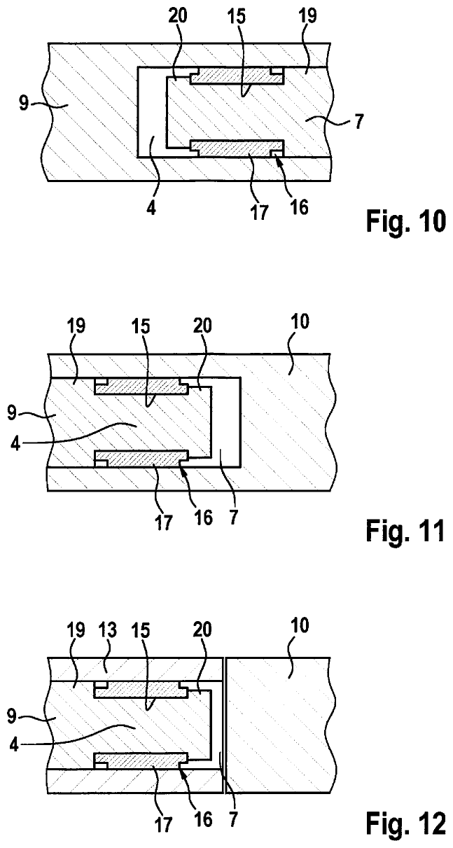

FIG. 10 describes a detail of pin 7 including groove 15. Groove 15 is laterally restricted by two groove shoulders 19 and 20. Groove shoulders 19, 20 have different extensions in the radial direction in relation to the axis of pin 7. For example, groove shoulder 19, which faces drive unit 1, is higher than groove shoulder 20, which faces gear unit 2, or more precisely, gear axle 9. The height of groove shoulders 19, 20 may be understood to start at a groove base or groove bottom, which is restricted by groove shoulders 19 and 20 on the right and left. The groove base or also the groove bottom is not provided with such.

If alignment element 7 and counter element 4 are denoted as connection components 4, 7, of which one may be present as a pin in each case, then it may generally be said that the lower groove shoulder 20 is facing away from the particular unit whose connection component 4, 7 is developed as a pin 4, 7. In other words, it may also be said that groove shoulder 19 having the greater height is always provided on the particular side on which the pin as connection component 4, 7 is connected.

FIG. 11 shows a gear axle having a counter element 4 in the form of a pin, which is developed on gear axle 9. Accordingly, a trough 7 as alignment element 7 is developed on housing 10 of drive unit 1. In this example, tolerance ring 16 sits on counter element 4 in the form of a pin of gear axle 9. Annular groove 15 is then developed on the pin as counter element 4.

Similar to FIG. 11, FIG. 12, too, shows a gear axle 9 having a counter element 4 as a pin. In this particular embodiment, trough 7 as an alignment element 7 is developed on motor flange 13, which is secured in position on drive unit 1. Trough 7 may be developed in motor flange 13 in the form of a hole or a hollow including a bottom. In this example, tolerance ring 16 sits on counter element 4 in the form of a pin of gear axle 9 in annular groove 15.

Not shown but clearly understood in view of the above explanations is a variant in which alignment element 7 is developed in the form of a pin 7, which is directly attached to housing 10 of drive unit 1 or is even molded thereon.

Also not shown but understood, the pin as counter element 4 may also be mounted on gear axle 9 or be part of gear axle 9, the pin as counter element 4 not engaging in a trough 7 as alignment element 7 in the flange, but engage with housing 10 of drive unit 1. Pin 4 as counter element 4 may project through a hole in motor flange 13 and reach housing 10 via this path.

1-14. (canceled)

15. An actuator, comprising:
a drive unit; and
a gear unit, wherein the drive unit is secured in place on the gear unit, in an axial direction of a gear axle of the gear unit, and wherein the axial fixation is provided by a fixation element, which is introduced between an alignment element of the drive unit and a counter element of the gear unit.

16. The actuator of claim 15, wherein the counter element is part of the gear axle of the gear unit.

17. The actuator of claim 16, wherein the alignment element and the counter element are complementary to each other.

18. The actuator of claim 17, wherein the alignment element and the counter element as connection components are complementary, such that one of the two connection components includes a plug, which is a plug-type connection component, and another of the two connection components includes a socket.

19. The actuator of claim 18, wherein the fixation element is mounted on the respective plug-type connection component.

20. The actuator of claim 19, wherein the plug-type connection component has an intermediate region in the form of an annular groove, and a fixation arrangement is accommodated in the annular groove.

21. The actuator of claim 20, wherein the annular groove has lateral groove shoulders, which have different extensions starting from a groove bottom.

22. The actuator of claim 21, wherein the higher groove shoulder is provided on a particular side of the groove bottom on which the plug-type connection component is connected to the gear unit or to the drive unit.

23. The actuator of claim 15, wherein the fixation arrangement includes a spring element.

24. The actuator of claim 23, wherein for an axial fixation with the aid of the fixation arrangement, the fixation is releasable.

25. The actuator of claim 23, wherein an axial fixation strength of the axial fixation is a function of the configuration of the fixation arrangement.

26. The actuator of claim 25, wherein the fixation arrangement is a tolerance ring, which has waves at its outer circumference, which are at least partially compressed in an installed state between the alignment element and the counter element.

27. The actuator of claim 26, wherein the fixation strength is adjustable based on the configuration of the tolerance ring via a dimensioning of the waves on the tolerance ring, and wherein the dimensioning includes a length of individual waves or a number of waves.

28. The actuator of claim 15, wherein the alignment element is on a housing of the drive unit or is attached to a housing.

29. The actuator of claim 15, wherein the alignment element is on a housing of the drive unit or is attached to a housing, in particular with the aid of a motor flange.

30. The actuator of claim 15, wherein the fixation arrangement includes a tolerance ring.
